(19) United States
(12) Patent Application Publication
(10) Pub. No.: US 2020/0254406 A1
(43) Pub. Date: Aug. 13, 2020

(54) DISPENSER AND MIXER FOR DISPOSABLE CARTRIDGES

(71) Applicant: Sulzer Mixpac AG, Haag (CH)

(72) Inventor: Clifford BECKETT, Thatcham Berkshire (GB)

(21) Appl. No.: 15/776,171

(22) PCT Filed: Nov. 15, 2016
(86) PCT No.: PCT/EP2016/077783

§ 371 Date: May 15, 2018

(30) Foreign Application Priority Data
Nov. 16, 2015 (EP) 15194787.6

(51) Int. Cl. B01F 13/00; B01F 7/00

(52) U.S. Cl. CPC B01F 13/0027; B05C 17/00566; B01F 7/00141; B01F 7/00291

(57) ABSTRACT

A dynamic mixer attachment is disclosed, which is adapted for use with conventional multi-component cartridges. The mixer has dispensing and drive axes that are offset relative to each other to enable use of the mixer with conventional multi-component cartridges. Also disclosed is a dispenser adapted for use with the mixer attachment and conventional multi-component cartridges.

### CROSS-REFERENCE TO RELATED APPLICATION

This application is a U.S. National Stage application of International Application No. PCT/EP2016/077783, filed Nov. 15, 2016, which claims priority to European Patent Application No. 15194787.6, filed Nov. 16, 2015, the contents of each of which are hereby incorporated herein by reference.

### BACKGROUND

### Field of the Invention

The present disclosure relates to a dispenser and mixer for disposable cartridges holding two or more component viscous materials to be dispensed and mixed on dispensing to form a dispensed material, in particular although not exclusively cartridges for two-component adhesives or sealants.

### Background Information

A wide range of two (or more) component cartridges are commercially available in standard sizes and shapes, typically having an arrangement of side by side or concentric barrels, one holding each component viscous material. Many of these cartridges can be used with a variety of, typically hand-held, dispensers using different dispensing mechanisms (manual, mechanic actuation; electric actuation; pneumatic actuation; etc.) for advancing a respective plunger into each barrel of the cartridge to dispense the component materials. Typically, a disposable mixer is attached to a dispensing end of the cartridge, in fluidic communication with respective outlets of the barrels, to receive and mix the materials dispensed from the barrels and to dispense the mixed material at a dispensing end of the mixer. The mixer typically comprises a length of a hollow tube with static mixing blades or other interleaving elements disposed along the material flow-path to mix and interleave the materials on their way to the dispensing end. To achieve thorough and reliable mixing, these mixers must be of a certain minimum length dictated by a variety of factors including the material viscosities and miscibilities.

Mixers with a rotatable mixing element, often referred to as dynamic mixers, are also known. These mixers can provide improved mixing of dispensed materials as compared to static mixers, as the materials are actively interleaved by a rotating mixing element on their way to the dispensing end. The rotatable mixing element has a coupling, for example square or spline, for engagement by a drive shaft of a dispenser adapted to work with the dynamic mixer, thereby enabling the dispenser to rotate the rotatable element insider the dynamic mixer to mix the dispensed materials. However, current dynamic mixers and associated dispensers are not interoperable with standard commercially available cartridges of the type described above, which are adapted to work with static mixers.

### SUMMARY

It would desirable to improve mixing of materials dispensed from standard commercially available cartridges adapted for use with static mixers.

In a first aspect there is disclosed a mixer as set forth below.

By providing a mixer with a mixing element rotatable around a mixer axis off-set from a drive axis of a transmission element, the location of mixing and driving the mixing element are decoupled, allowing the mixer to be used with standard, commercially available multi-component cartridges (such as two-component side-by-side or concentric barrelled cartridges) adapted for static mixers. Thus, the claimed mixer extends the benefit of improved mixing over a shorter flow-path associated with dynamic mixing to standard commercially available cartridges that do not have special provisions for driving a rotatable mixing element. By contrast, conventional dynamic mixers are not suitable for use with such standard cartridges, as the mixing and driving axes coincide for such mixers. This would require the provision of specially adapted cartridges allowing, for example, a mixer drive shaft to extend centrally through the cartridge, which is not possible with standard side-by-side or concentric cartridges.

In some disclosed embodiments, the mixing and driving axes are substantially parallel. For example, the transmission and mixing elements may be configured as meshing gears (cogged wheels), arranged to rotate around respective mutually parallel axes. Other arrangements are of course equally possible, for example using bevel gears with respective axes of rotation arranged at an angle, for example perpendicularly, to each other. Other transmission arrangements with offset axes of rotation can equally be used in various embodiments. The transmission ratio may provide a reduction or increase in the rate of rotation, as required by the particular application. Typically, the transmission will provide reduction.

In some embodiments, a mixer housing accepts the rotatable mixing element for rotation, for example along a longitudinal axis of the mixer housing. The housing is configured to sealingly engage the outlets of a two or more material cartridge and provides a flow path for materials from the cartridge past the rotatable mixing element and to the dispensing end of the mixer. The housing may comprise a longitudinally elongate hollow conduit member around the rotatable mixing element and a back plate comprising a bushing in which the rotatable mixing element is journalled. The back plate may further provide an inlet for sealingly engaging the outlets of the cartridge. The inlet may be common to the cartridge outlets, for example sealing around both/all outlets of the cartridge or may comprise separate inlet ports, one for sealing to each outlet.

The rotatable mixing element may include a cogged wheel adjacent the rear end. A transmission element with a further cogged wheel may be provided, for example held in a fashion similar to the rotatable mixing element, journalled between bushings in a laterally extending extension portion of the conduit member and the back plate. The further cogged wheel is disposed so that its cogs mesh with the cogs of the cogged wheel of the rotatable mixing element. A rear end of the transmission element extends through the back plate and is shaped to provide a coupling for a drive shaft to drive the transmission element, for example a square hexagonal, octagonal, generally polygonal or spline coupling, either internal or external (female/male). In this way, the axis of rotation of the transmission element (and hence the drive axis) is laterally offset from the axis of rotation of the rotatable mixing element, since the respective bushings are laterally off-set from each other. Irrespective of the specific arrangement of the transmission element, mixing element and mixer housing, the off-set is chosen so that the coupling of the transmission element can engage a drive shaft of a dispenser configured for use with the mixer when the mixer is attached to a cartridge held in the dispenser.

In some embodiments, a sealing member extends rearwards from the back plate. The sealing member will generally be configured to seal around an outlet feature of a corresponding cartridge or family of cartridges. For example, the sealing member may be cylindrical, for example having an annular cross-section, or frustoconical. More complex configurations of the sealing member are equally possible, for example the sealing member may include separate inlet ports, one for each cartridge outlet. In some embodiments with separate inlet ports, the inlet ports are prong shaped for engaging, either inside or outside, corresponding outlet ports for the respective materials of the cartridge.

An outer surface of the sealing member may include a neck to act as a detent for a fastening member that may be disposed rotatably around the sealing member to engage a corresponding feature on the cartridge to sealingly secure the mixer to the cartridge. The fastening member may be configured as a threaded collar to engage a corresponding thread on the cartridge, as a bayonet fastener, or any other suitable fastening arrangement. In some embodiments the fastening member may be disposed on the cartridge and the sealing member formed with corresponding fastening features for engagement with the fastening member.

In some embodiments, components of the mixer, such as the conduit member, back plate and/or mixing and/or transmission elements are manufactured by injection moulding of a suitable polymer material, and then assembled and secured together by, for example, laser welding. Suitable polymer materials may be a range of plastics for example Nylon™, PE, ABS, etc. The fastening member may be secured to the assembly by a snap fit on the sealing member. In particular the back plate and fastening member may be designed to fit a specific commercially available cartridge or family of cartridges, while the conduit member and mixing and transmission elements may be designed to be generic and independent of the cartridge, thus limiting the number of moulds required.

In some embodiments, the transmission element is part of the mixer and disposed in the mixer housing.

In a second aspect there is disclosed a dispenser as set out below.

By providing a drive shaft for engaging and driving a dynamic mixer off-set from a cartridge accepting space, a dynamic mixer as described above can be attached to the dispenser and a cartridge held in the dispenser so that the drive shaft engages the dynamic mixer to drive the rotatable mixing element. By providing the drive shaft to one side of the cartridge accepting space, the drive shaft can be disposed to one side of a cartridge held in the dispenser in the cartridge accepting space and the dispenser can thus be used with cartridges not specifically adapted for use with a dynamic mixer. In this way, materials dispensed by actuation of a dispensing mechanism of the dispenser from a standard cartridge held in the dispenser can be dynamically mixed to form the dispensed mixed material.

In some embodiments, a front portion of a holder for holding the cartridge relative to the dispensing mechanism of the mixer defines a cartridge locating feature. The cartridge locating feature may comprise a slot or hole in the front portion, for example in a front plate, configured so that a cartridge held in the dispenser ready for dispensing is disposed with a neck of the cartridge through the slot or hole while the cartridge is held against the dispensing pressure applied by the dispenser by the front plate engaging a shoulder portion of the cartridge. The front plate may be disposed at one end of a spacer arrangement secured to a body portion housing the drive mechanism to accommodate a cartridge between the drive mechanism and front plate. The spacer arrangement may be in the form of, for example, one or more rods or strips linking the front plate to the body portion; a cradle or trough shaped member linking the front plate and body portion; a hollow cylindrical member for accepting the cartridge and comprising the front plate at one end and removably securable to the body portion at the other end; etc. In embodiments where the cartridge locating feature is arranged as a slot, the cartridge can be inserted in the dispenser by locating it against the body portion and allowing the neck of the cartridge to drop into the slot, for example.

In some embodiments, the drive shaft and the dispensing mechanism are driven by separate respective electric motors. The motor driving the dispensing mechanism may be disposed adjacent the dispensing mechanism and the motor driving the drive shaft may be disposed adjacent the drive shaft. The drive shaft may be directly driven, for example be secured or part of the rotor of the respective motor, or may be coupled to the motor by a gear box. In some embodiments, the same motor may drive the dispensing mechanism and drive shaft. For example, the drive shaft may extend over the length of the dispenser, from a motor adjacent the dispensing mechanism to the front of the dispenser where the mixer can be coupled to both a cartridge loaded in the dispenser and to the drive shaft. More generally, the dispensing mechanism and drive shaft may be driven by the same or different arrangements and/or modalities, directly or via transmission arrangement(s). For example, either or both may be driven by any combination of one or more of manual mechanic activation; pneumatics; hydraulics; and electric arrangements.

In some embodiments, the dispenser is a hand-held dispenser. For example, the body portion may be shaped as a handle for holding by a user's hand. The handle may include one or more actuators for actuating the dispensing mechanism and drive shaft. For example, a single actuator, such as a trigger lever or button may be provided to actuate both the dispensing mechanism and the drive shaft.

In a third aspect, there is disclosed a kit of parts as disclosed herein.

In a fourth aspect, there is provided a dispenser as disclosed herein.

In some embodiments, the dispenser comprises a body portion housing a first drive mechanism for advancing a plunger into a cartridge held relative to the body portion to dispense viscous material from the cartridge. The body portion also houses a second drive mechanism for driving a drive shaft. The drive shaft is configured to engage a mixer to drive the mixer to mix viscous materials dispensed from the cartridge. A cartridge holder configured to hold a cartridge relative to the body portion is coupled to the body portion at a common portion. A handle portion extends from the common portion to be held in the hand of a user operating the dispenser. A rear portion extends from the common portion to one side of the handle portion away from the cartridge holder and houses an electric motor for driving the first drive mechanism. A guard portion extends in a direction along the handle portion from the common portion between the handle portion and the cartridge holder and houses an electric motor for driving the second drive mechanism. A space between the handle and guard portion accommodates the hand of a user holding the dispenser.

Advantageously, by driving the second drive mechanism for the drive shaft with a separate electric motor, independent control of dispensing and mixing is facilitated and complicated transmission arrangements for transmitting torque to both the first and second drive mechanisms can be avoided. Further, by housing the second electric motor in a guard portion configured as described above, efficient use is made of available space. This is because the second electric motor does not take up space in the common portion, which can thus be used for housing a portion of the control system, for example housing a selector for selecting a control variable to control the dispensing and/or mixing. Rather, the second electric motor is in this way housed underneath the common portion and in front of the handle portion, in a space which would otherwise not be utilised. Instead of, or in addition to, housing further control elements, the common portion might therefore be designed to be smaller, and/or slimmer than would otherwise be possible.

In some embodiments, the handle and guard portions are joined opposite the common portion by a bottom portion. Advantageously, in this way, the guard portion contributes to the structural strengths and rigidity of the dispenser. The bottom position may be configured to accept a battery pack, for example providing a securing feature such as a set of rails and electrical contacts for engaging the battery. In this arrangement, the battery pack is secured to the body portion by both the handle portion and the guard portion, therefore further enhancing the structural strength of the dispenser.

It will be understood that the dispenser of the second aspect and corresponding embodiments are part of the third aspect and may be configured additionally in line with the fourth aspect and its embodiments.

### DESCRIPTION OF THE DRAWINGS

The invention will be explained in more detail hereinafter with reference to the drawings.

FIG. 1 illustrates a dispenser loaded with a cartridge and mixer;

FIG. 2 illustrates the dispenser of FIG. 1 without the cartridge and mixer;

FIG. 3 illustrates an exploded view of the mixer and a front portion of the dispenser loaded with the cartridge;

FIG. 4 is a rear view of the mixer with a first arrangement for engaging the cartridge;

FIG. 5 is a rear view of the mixer with an alternative arrangement for engaging the cartridge; and

FIG. 6 is a partially cut away view of the dispenser exposing arrangements for driving dispensing and mixing.

### DETAILED DESCRIPTION OF THE EMBODIMENTS

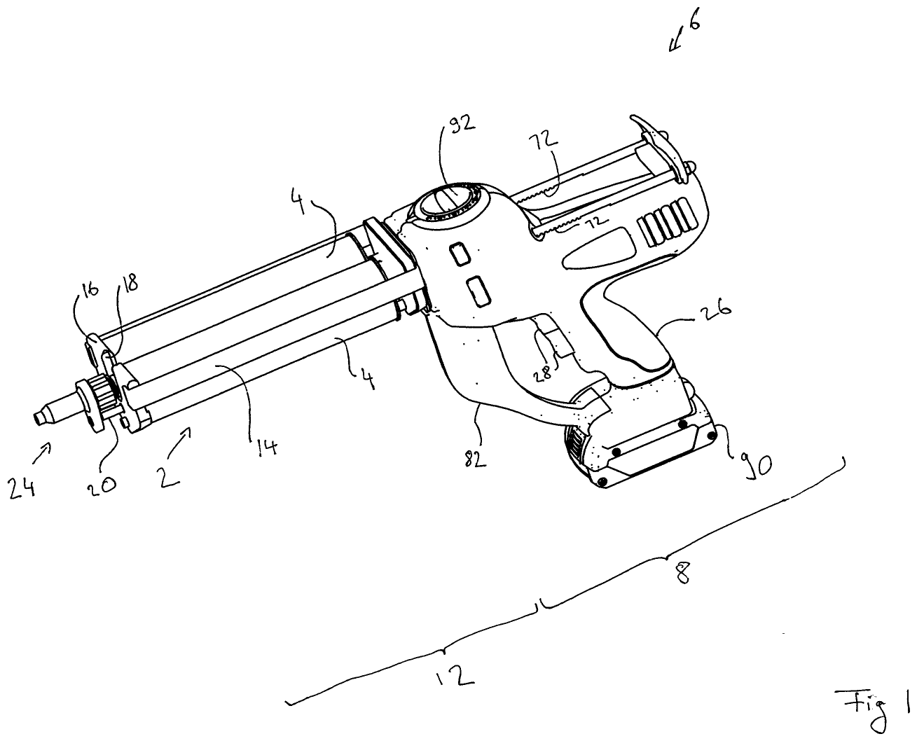

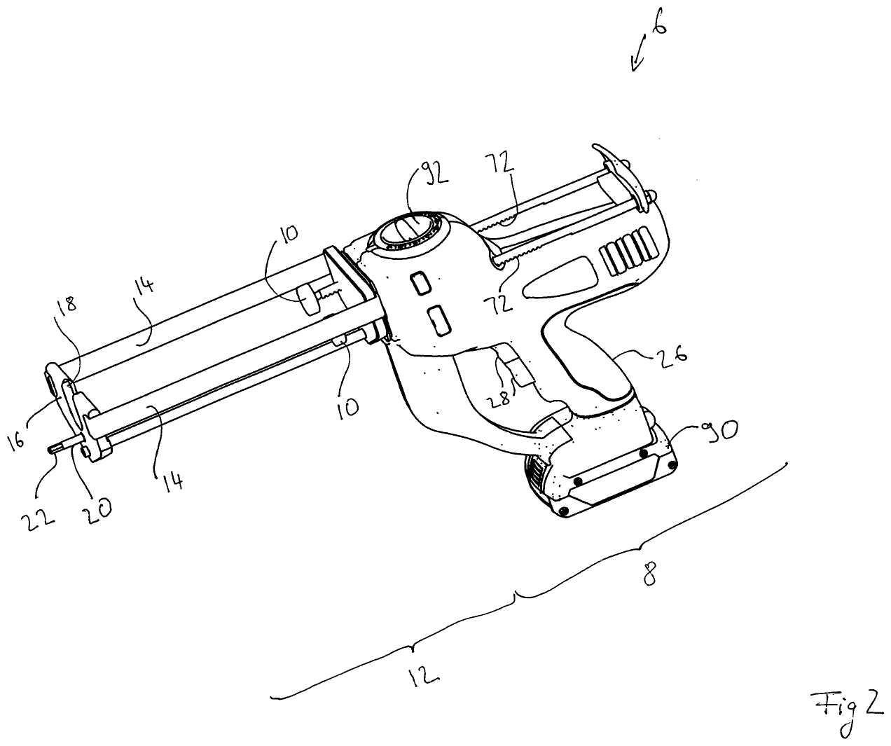

With reference to FIGS. 1 and 2, a cartridge 2 houses a respective viscous material in each of two side-by-side barrels 4, each having an outlet port in a neck of the cartridge 2. A dispenser 6 has a body portion 8 housing a drive mechanism for driving a set of two plungers 10, each for engaging a corresponding piston in a respective barrel 4. In use, the cartridge 2 is held relative to the body portion 8 (and hence the drive mechanism) in a cartridge holder 12. The cartridge holder 12 is formed by a shaped sheet metal member forming a cradle 14 and secured to the body portion 8 at a first end. At a second, opposed end, the cradle is closed by a front plate 16. A slot 18 in the front plate 16 accepts a neck of the cartridge 2 so that a shoulder of the cartridge 2 rests against the front plate 16 against the dispensing pressure applied to the viscous materials inside the cartridge 2 by the plungers 10.

A drive shaft 20 extends through the front plate 16 and provides a shaped coupling 22 at an end protruding from the front plate 16. The drive shaft extends longitudinally along a portion of the cradle 14 to one side (below) of the cradle. A mixer 24 is configured for mixing materials dispensed from the cartridge 2, driven by the drive shaft 20. In use, the mixer 24 is sealingly attached to the cartridge 2 and coupled to the drive shaft 20 for driving the mixer 24.

The body portion 8 comprises a handle portion 26 configured for being held by the hand of an operator and having actuating triggers 28 for actuation by fingers of a hand holding the handle portion 26. One of the actuating triggers 28, when actuated, is configured to drive the plunger forward into a cartridge held in the cartridge holder 12 and to cause rotation of the drive shaft 20, thereby causing mixing of materials dispensed from the cartridge as the plungers 10 apply a dispensing pressure to the materials in the cartridge. The other one of the actuating triggers 28, when actuated, is configured to cause the plungers 10 to be retracted. In this way, a user can hold the handle portion 26 in one hand and operate one of the actuating triggers 28 with one or more fingers of the same hand.

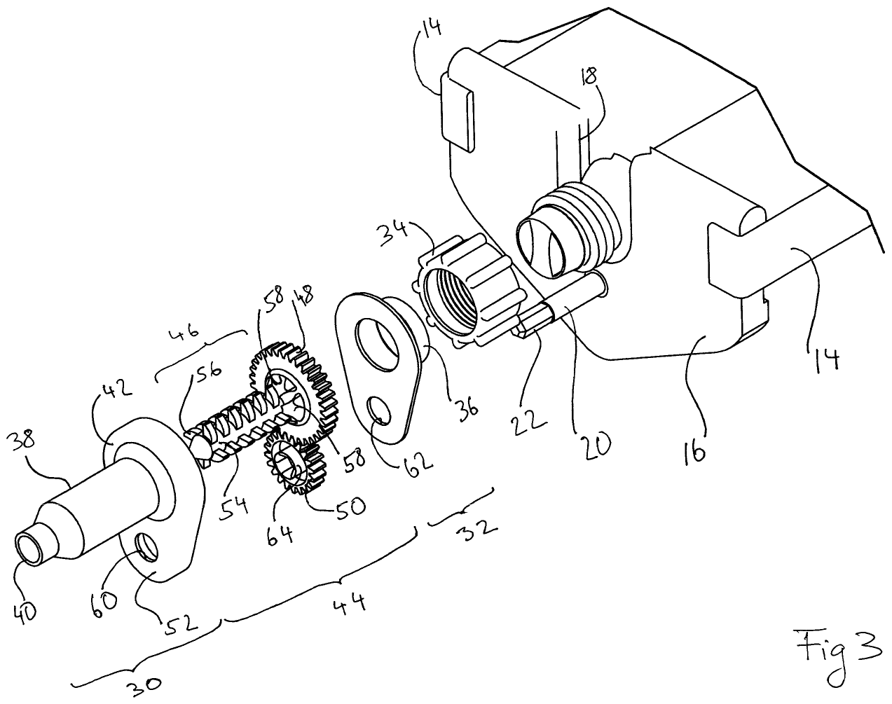

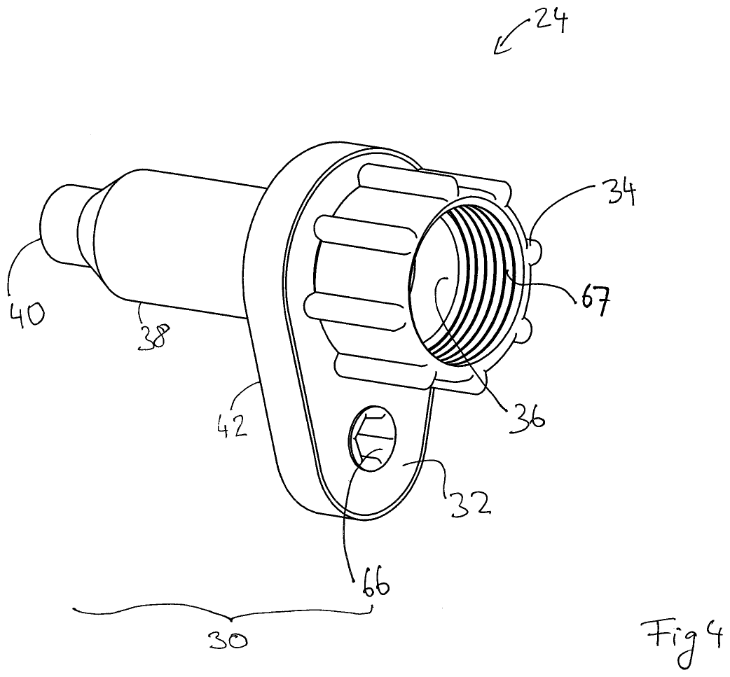

With reference to FIGS. 3 and 4, the mixer 24 comprises a mixer body 30 and a back plate 32, which are sealed together, for example by laser welding, to form a mixer housing. An adapter nut 34 is provided as a snap fit on the back plate 32 around a mixer inlet 36 in the back plate 32 for engaging a cartridge outlet in the neck of the cartridge 2. The mixer inlet is configured as an annular or frustoconical wall to seal around the neck. An outer wall of the mixer inlet 36 includes a neck, groove or other detent which accommodates a ridge on the adapter nut 34 to secure the adapter nut 34. The adapter nut 34 is rotatable relative to the back plate 32 to, in use, engage a thread on the neck of the cartridge 2, to secure the mixer 24 to a cartridge 2 held in the cartridge holder 12.

The mixer body 30 comprises an elongated front portion 38 extending from a dispensing end 40 of the mixer body 30 to a back portion 42, which forms a shoulder around the front portion 38. A mixing element 44 is disposed in the mixer body 30 with an elongated portion 46 extending inside the front portion 38 and a transmission portion 48 disposed in the back portion 42. The transmission portion 48 is shaped as a cogged wheel to provide a gear for engagement with a driving gear 50, shaped as another cogged wheel and disposed in a lateral portion 52 of the back portion 42 so as to mesh with the transmission portion 48.

The mixing element 44 comprises a shaft 54 extending longitudinally from the transmission portion 48. Mixing vanes 56 extend laterally from the shaft 54. The mixing element is journalled at one end by the front portion 38 disposed around the mixing vanes 56 and at the other end by the mixer inlet 36 disposed around a rearwards projection from the transmission portion 48, with the transmission portion 48 disposed against or adjacent the shoulder formed by the back portion 42 around the front portion 38. A flow path for materials from the neck of the cartridge 2 to the dispensing end 40 of the mixer body 30 is provided through the mixer inlet 36 and inlet openings 58 provided in the transmission portion 48 around the shaft 54.

Each of the back portion 42 of the mixer body 30 and the back plate 32 include a respective bushing 60, 62 to one side of the elongated front portion 38 for journaling a respective front and back journal portion 64 extending longitudinally from the driving gear 50, with the driving gear 50 rotatably held in place between the mixer body 30 and the back plate 32 with the journal portions 64 in the bushings 60, 62. The mixer body 30 and back plate 32 are arranged to seal around the journal portions or other portions of the driving gear 50 to prevent egress of materials from the cartridge 2 from the back portion 42 or back plate 32. The back journal portion 64 includes a coupling 66 for engagement by the coupling 22 of the drive shaft 20 to drive the driving gear 50 and extends rearwards through the respective bushing to provide access to the coupling 66 and enable the drive shaft 20 to be coupled to the coupling 66 when the mixer is in place.

The back portion 42 extends laterally from the elongated front portion 38 so that, in particular, the bushings 60, 62, and hence an axis of rotation of the driving gear 50, are offset from the elongated front portion 38 and mixer inlet 36 and hence from an axis of rotation of the mixing element 44. In this way, by laterally off-setting the axis of rotation (and coupling) of the driving gear 50 from the mixer inlet 36, the mixer 24 can be attached to a standard cartridge held in the dispenser 6 with the drive shaft 20 laterally off-set from the cartridge, for example below the cartridge as illustrated.

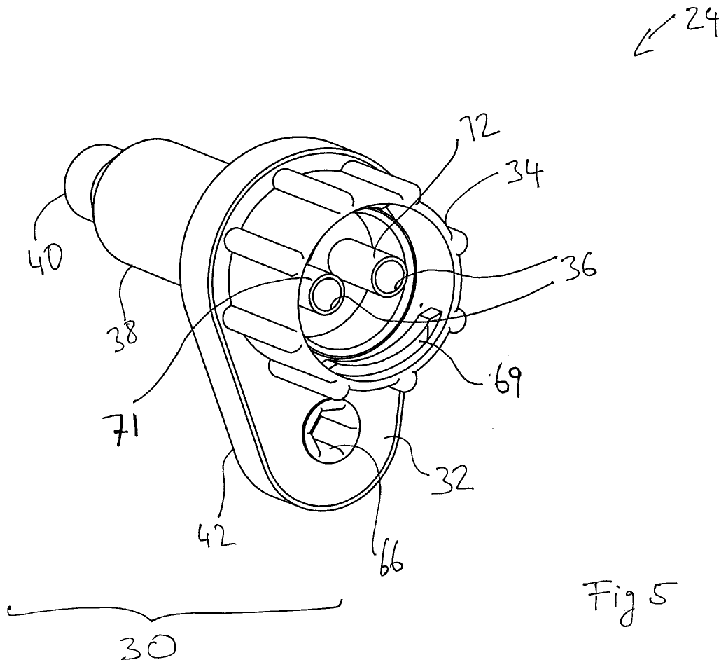

While, as depicted in FIG. 4, the adapter nut 34 has, in some embodiments, a thread 67 to engage a corresponding thread on a neck of a cartridge, it will of course be understood that other securing mechanisms are equally possible, for example a bayonet fixing 69 as depicted in FIG. 5, for engaging corresponding bayonet lugs on a neck of a cartridge. Of course, the location of the bayonet fixing and lugs may be interchangeable in accordance with various embodiments. Further, while embodiments described above with reference to FIG. 4 have been described as having a mixer inlet 36 configured as an annular or frustoconical wall to seal around the cartridge neck (and hence to seal around all outlets from the cartridge), other arrangements are of course equally possible. For example, in some embodiments the back plate 32 is configured with separate, individual mixer inlets 36, each one for engaging a corresponding outlet port of the cartridge. In some embodiments, the individual inlet ports are configured as prongs 71, each prong 71 engaging an inside wall of a cartridge outlet port with its outer wall, thereby reducing the risk of cross-contamination when the mixer is withdrawn from the cartridge. It will be understood that the configuration of the mixer inlet 36 and adapter nut 34 are independent of each other so that embodiments extend to various combinations of the features discussed above, that is for example inlet prongs with a threaded adapter nut, a single inlet opening with bayonet fixings, etc.

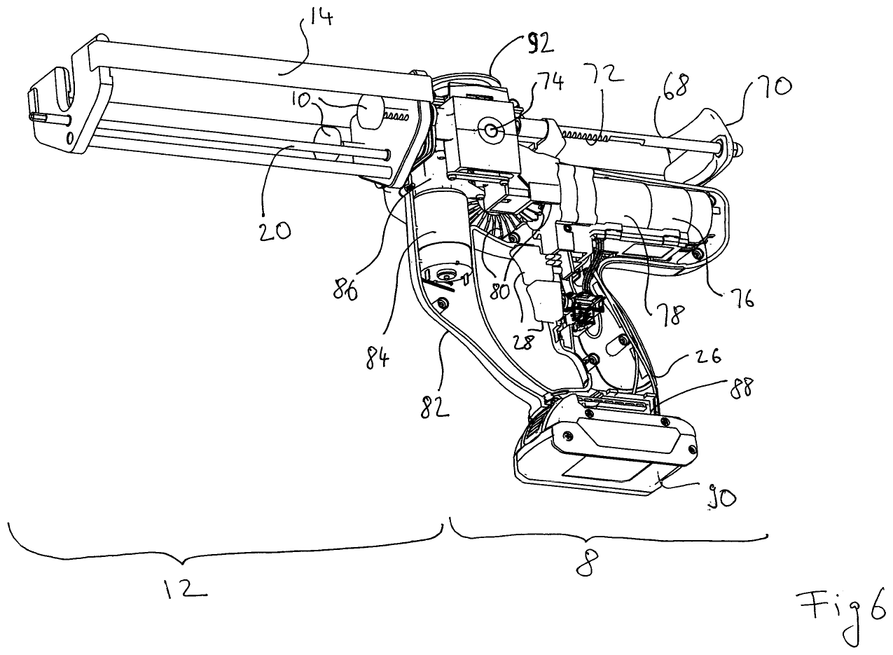

Returning to FIGS. 1 and 2, and with further reference to FIG. 6, the drive mechanism for the plungers 10 and mixer 24 is now described in further detail. Each plunger 10 is coupled to a push rod 68, which is slideably held in the body portion 8. The push rods 68 are joined at their rear ends by a cross piece 70. Each push rod 68 has a rack surface 72 engaging a pinion (not visible in FIG. 6) journalled by its pinion axis 74 in the body portion 8. A first electric motor 76 is disposed in a rear portion of the body portion 8 extending rearward from the handle 26 and coupled to a first gearbox 78. The first gearbox 78 is coupled to a system of bevel gears 80 (two of which are visible in FIG. 6) which in turn drive the pinion about its axis 74. Due to its engagement with the rack surface 72, rotation of the pinion drives the push rods 68, and hence the plungers 10 forwards or backwards, to apply dispensing pressure or retract the plungers, as needed. A guard portion 82 of the body portion 8 is disposed forward of the handle portion 26 and defines a space between the guard portion 82 and handle portion 26 in which the fingers of a user's hand can be accommodated. The guard portion 82 houses a second electric motor 84 coupled to a second gearbox 86, which transmits torque from the second electric motor 84 to the drive shaft 20. At a distal end of the body portion 8, distal to a common portion of the body portion and the first and second electric motors 76, 84, the handle portion 26 and guard portion 82 are joined by a battery holder portion 88 configured to provide a securing arrangement for securing a battery pack 90 to the body portion 8. The securing arrangement comprises a mechanical feature for engaging the battery pack 90 for securing it to the body portion 8, such as a slide rail and/or click fit, and electrically conductive contacts for engaging corresponding contacts on the battery pack 90, for example by a spring loaded engagement with one of the contacts acting as a spring.

A control system is coupled to the electric motors 76, 84 and the actuating triggers 28 discussed above to control energisation of the electric motors by applying a voltage from the battery pack 90 to the motor terminals. In some embodiments, a control variable selector 92 is incorporated with the body portion 8, for example as a rotary selector on top of the body portion 8 as depicted in FIGS. 1, 2 and 6. The control variable selector can be used by a user to set a corresponding control variable for the control system to control the electric motors accordingly. Control variables may include a dispensing speed, a dispensing torque, or a volume to be dispensed for a single actuation of one of the trigger actuators 28, by setting a corresponding value using the control variable selector 92. Alternatively, or additionally, control variables such as dispensing torque or speed can be set by a degree of actuation of one of the actuating triggers 28, for example an amount of depression of one of the actuating triggers 28 corresponding to a dispensing speed.

In use, a standard cartridge compatible with the dispenser 6 is inserted into the cartridge holder 12, for example by engaging a rear end of the cartridge with the plungers 10 and allowing the neck of the cartridge to drop into the slot 18. A mixer as described above is then coupled to the neck of the cartridge, to seal the mixer inlet to the cartridge outlet, and to the drive shaft 20 to allow the drive shaft 20 to drive the mixing element 44 inside the mixer 24. When a user then operates the dispenser, by activating one of the actuating triggers 28 and operating the trigger with one or more fingers of the same hand, the electric motor or motors are energized to activate the driving mechanism and drive shaft, causing viscous materials to be dispensed from the cartridge into the mixer and rotation of the mixing element in the mixer to mix the viscous materials as they flow through the mixer.

Having read the present disclosure, the skilled person will have gained a detailed understanding of the present invention and will appreciate that various modifications of the specific embodiment described above by way of example with reference to the drawings are possible, for example as indicated above, and fall within the scope of the appended claims. Thus, the specific description above is made by way of illustration and not limitation.

1. A mixer for attachment to a cartridge holding two or more viscous materials to mix materials dispensed from the cartridge, the mixer comprising:
a mixer housing defining an inlet for the viscous materials to be mixed, an outlet and a flow path for the viscous materials between the inlet and the outlet;
a mixing element configured to rotate in the flow path between the inlet and the outlet about a mixer axis to mix the viscous materials flowing from the inlet to the outlet; and
a transmission element defining a coupling configured to couple to a drive shaft and coupled to the mixing element to transmit a driving torque from the coupling to the mixing element, the transmission element being configured to rotate about a drive axis off-set from the mixer axis.

2. The mixer as claimed in claim 1, wherein the mixer and drive axes are substantially parallel to each other.

3. The mixer as claimed in claim 1, wherein the mixer housing defines an elongate mixing conduit in which the mixing element is disposed and comprises a back plate defining the inlet ports.

4. The mixer as claimed in claim 3, wherein the mixer housing comprises a lateral portion extending laterally from the elongate mixing conduit, and the transmission element is disposed in the lateral portion.

5. The mixer as claimed in claim 4, wherein the mixing element and the transmission element are each journalled in a respective bushing in the back plate.

6. The mixer as claimed in claim 3, wherein a first moulding comprises the elongate mixing conduit and lateral portion and a second moulding comprises the back plate, the mixer housing being configured to be assembled from the first and second mouldings.

7. A dispenser comprising:
a body portion housing a drive mechanism configured to drive a plunger into a cartridge held relative to the drive mechanism;
a cartridge holder configured to hold a cartridge in a cartridge accepting space relative to the drive mechanism; and
a drive shaft having a coupling at one end configured to engage a mixer coupled to a cartridge held in the cartridge accepting space, the drive shaft being disposed to a side of the cartridge accepting space.

8. The dispenser as claimed in claim 7, wherein the dispenser is configured for hand-held operation.

9. The dispenser as claimed in claim 8, wherein the body portion is shaped as a handle to facilitate the hand-held operation of the dispenser.

10. The dispenser as claimed in claim 7, wherein the drive shaft and drive mechanism are driven independently.

11. dispenser as claimed in any one of claim 7, wherein the drive shaft and drive mechanism are each driven by a respective electric motor.

12. The dispenser as claimed in claim 7, wherein the cartridge holder comprises a front plate defining an opening for accepting a neck of the cartridge there through and the drive shaft is disposed through the front plate to engage a mixer coupled to the cartridge held in the cartridge holder.

13. A dispenser, comprising:
a body portion housing a drive mechanism configured to drive a plunger into a cartridge held relative to the drive mechanism;
a cartridge holder configured to hold a cartridge in a cartridge accepting space relative to the drive mechanism; and
a drive shaft having a coupling at one end configured to engage a mixer coupled to a cartridge held in the cartridge accepting space, the drive shaft being disposed to a side of the cartridge accepting space,
the dispenser configured to drive a mixer as claimed in claim 1.

14. A dispenser configured to dispense two or more materials from a cartridge through a mixer as claimed in claim 1 and configured to drive the mixer.

15. A kit of parts comprising a mixer as claimed in claim 1 and a dispenser, the dispenser comprising a body portion housing a drive mechanism configured to drive a plunger into a cartridge held relative to the drive mechanism, a cartridge holder configured to hold a cartridge in a cartridge accepting space relative to the drive mechanism, and a drive shaft having a coupling at one end configured to engage a mixer coupled to a cartridge held in the cartridge accepting space, the drive shaft being disposed to a side of the cartridge accepting space.

16. A dispenser comprising:
a body portion housing a first drive mechanism configured to drive a plunger into a cartridge held relative to the body portion and a second drive mechanism configured to drive a drive shaft, the drive shaft being configured to engage a mixer for mixing viscous material dispensed from a cartridge held relative to the body portion;
a cartridge holder coupled to the body portion to configured to hold a cartridge relative to the body portion, the body portion comprising a handle portion configured to be held by a user to operate the dispenser;
a rear portion extending from the handle portion away from the cartridge holder and housing a first electric motor configured to drive the first drive mechanism; and
a guard portion extending in a direction along the handle portion between the handle portion and the cartridge holder, the guard portion housing a second electric motor configured to drive the second drive mechanism, the handle portion and guard portion defining a space configured to accept a hand of the user of the dispenser therebetween.

17. The dispenser as claimed in claim 16, wherein
the handle portion and guard portion are joined at one end by a common portion to which the cartridge holder is coupled and at another, opposed, end by a bottom portion, the space being defined between the bottom portion, handle portion and guard portion.

18. The dispenser as claimed in claim 17, wherein
the bottom portion is configured to accept a battery to power the dispenser.
